(19) United States
(12) Patent Application Publication
(10) Pub. No.: US 2015/0321031 A1
(43) Pub. Date: Nov. 12, 2015

(54) SAFETY DEVICE FOR MEDICAL ROOM

(71) Applicant: Larry N. Monn, Indianapolis, IN (US)

(72) Inventor: Larry N. Monn, Indianapolis, IN (US)

(21) Appl. No.: 14/270,786

(22) Filed: May 6, 2014

(51) Int. Cl. A62B 35/00

(52) U.S. Cl. CPC A62B 35/0043; A62B 35/0006

(57) ABSTRACT

A safety support system is disclosed for use in medical care rooms with a track providing a track path between locations, and retractor and a flexible support line with the retractor movable along the track. The retractor allows the line to feed out of the retractor slowly but grabs the line when there is a falling condition of a user wearing a non-restraint support. In the event of a fall, the retractor grabs the line. The support has a closure on the user's front side being openable by a one-handed operation of the user within less than three seconds to facilitate ready removal of said non-restraint support.

### BACKGROUND

The present invention relates to safety devices, and in particular devices to prevent or limit falls in a medical room.

Patient's in medical rooms need from time to time to be moved or move themselves. Falls are clearly bad, and so a variety of techniques have been used including walkers, nurse assistance, and hand railings. U.S. Pat. No. 5,456,655 to Morris shows a system with “an adjustable closure 72 along the spine of the patient as an attachment point . . . ”. A variety of restraint devices are also known.

### SUMMARY

The claims, and only the claims, recite the invention. In summary, the system may include one or more of a safety support system for use in medical care rooms with a track providing a track path between locations, and retractor and a flexible support line with the retractor is movable along the track. The retractor allows the line to feed out of the retractor slowly but grabs the line when there is a falling condition of a user wearing a non-restraint support. In the event of a fall, the retractor grabs the line. The support has a closure on the user's front side being openable by a one-handed operation of the user within less than three seconds to facilitate ready removal of said non-restraint support.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of one example of a safety device system in a medical room.

FIG. 2 is a front view of an example user support around a user.

FIG. 3 is a rear view of the support of FIG. 2.

FIG. 4 is a front view of the support of FIG. 2 with a user beginning to open it by a one-handed operation.

FIG. 5 is a front view of the support of FIG. 4 with the support opened.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

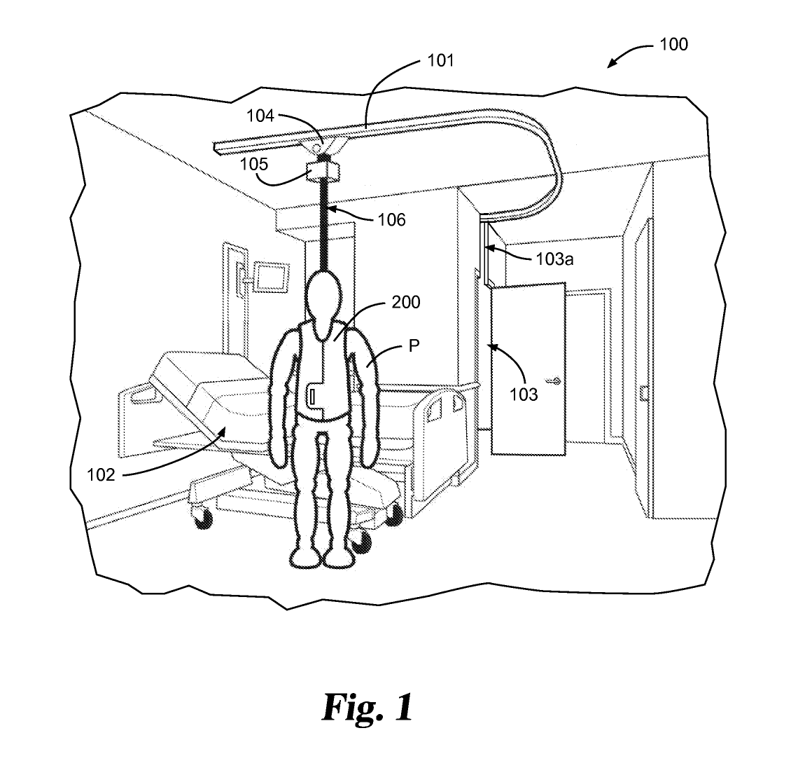

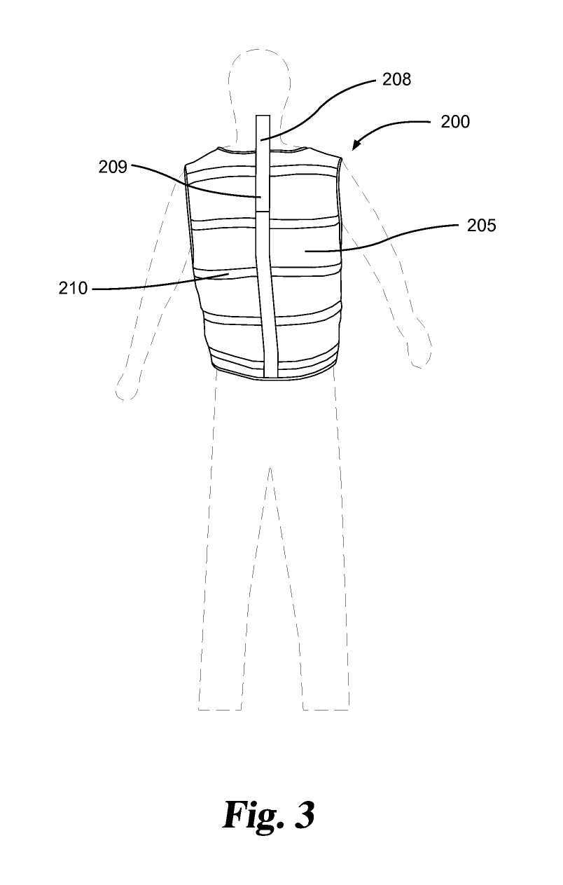

A safety support system 100 for use in medical care rooms is shown in one example in FIG. 1. The system comprises an overhead track 101 providing a track path between a first location (for example near bed 102) and at least one other location (for example bathroom 103). A retractor and a flexible support line 106 may be fed into and out of the retractor. The retractor 105 is movable along the track (via carriage 104 or otherwise), and the retractor allows the line to feed out of the retractor slowly but grabs the line when there is a falling condition of a user P. A removably attachable connection is provided between the line and a user support (for example vest 200 at loop 208 in FIG. 3).

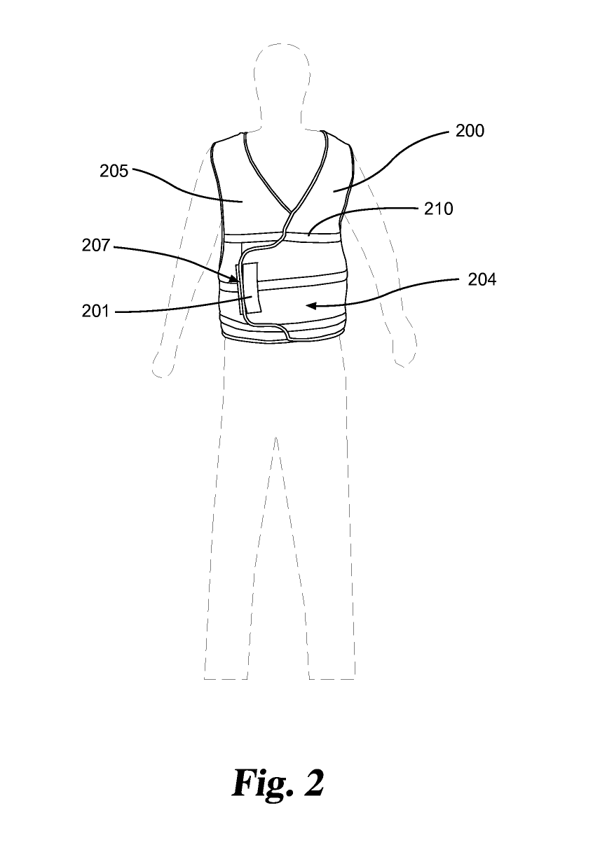

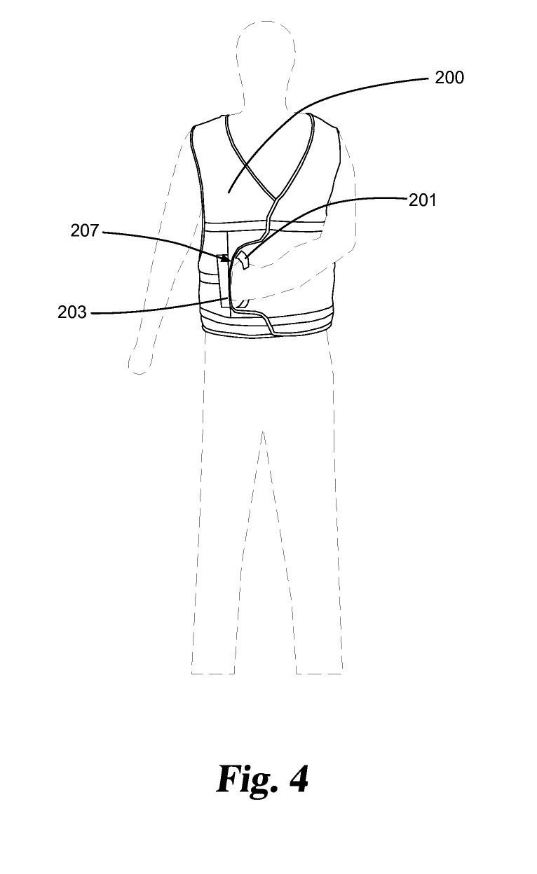

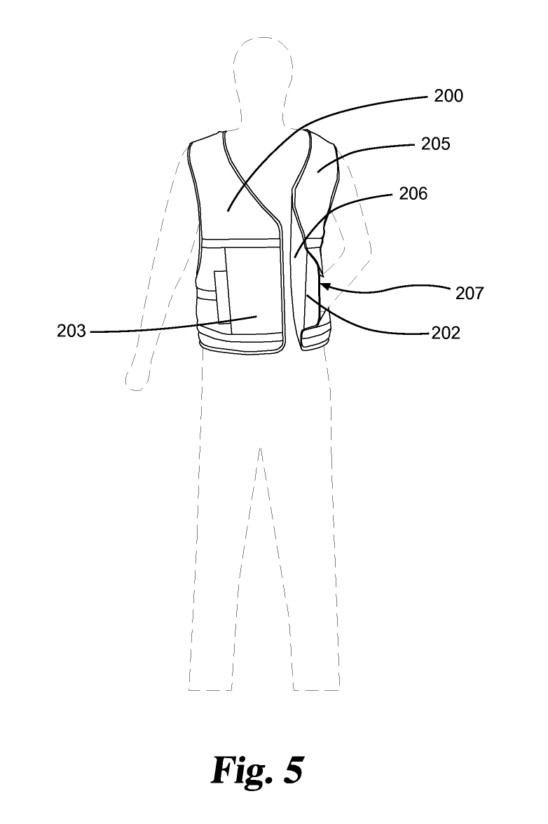

The user support is around the user P to support the user in the event of a fall, wherein the user support is a non-restraint support. It has a closure on the user's front side (FIG. 2) of the support, the closure being openable by a one-handed operation of the user (see for example FIGS. 4 and 5) within less than three seconds to facilitate ready removal of said non-restraint support.

Optionally, but not necessarily, the removably attachable connection comprises a hook and loop fabric 202 and 203 (see FIG. 5) interface located over an abdominal area 204 (see FIG. 2) of the user support. Optionally, but not necessarily, the non-restraint support is made of flexible material (205 exterior and/or 206 interior) and lacks any substantial hard lumps on its backside (FIG. 3) to facilitate user sleeping on their back while wearing the non-restraint support. Optionally, but not necessarily, the non-restraint support is made of flexible material (205 exterior and/or 206 interior) that is less than 3 centimeters, and preferably less than 2 centimeters, and more preferably less than 1 centimeter in thickness anywhere on its backside, including and straps. Optionally, but not necessarily, the non-restraint support lacks any metal components. Optionally, but not necessarily, comprises a vertically disposed strap-handle 201 positioned, at least in part, within two inches an outer free edge 207 (see for example FIGS. 2, 4 and 5) of the vest 200 and positioned generally over the hook and loop fabric interface 202, 203 when on a user. Optionally, but not necessarily, the non-restraint support is adapted for being washed in an automatic clothes washing machine. Optionally, but not necessarily, the non-restraint support comprises fabric which is anti-bacterial and is hypoallergenic.

Optionally, but not necessarily, the support such as vest 200 may include or not include various stronger strapping sewn or otherwise built in, including for example vertical strapping 209 (see for example FIG. 3), horizontal strapping 210 (see for example FIGS. 2 and 3), diagonal strapping, netting, reinforcement and/or otherwise. Optionally, but not necessarily, vertical strapping 209 includes loop 208 at or near its top and made from integral material, such as integral webbing.

Optionally, but not necessarily, the retractor 105 is lightweight and is non-motorized and is pulled along the track 101 by user tension on the support line. Optionally, but not necessarily, the support line 106 is (or at least includes) flexible webbing. Optionally, but not necessarily, upon a user fall, the retractor grabs the line such that line pulled out from the retractor is less than about 10 centimeters in a falling condition.

Optionally, but not necessarily, a radio notification signal sent to a nurse's station upon one or both of: (a) a falling event; and, (b) removal or attachment of the line to the support. Optionally, but not necessarily, the medical room (FIG. 1) may be such that a door jam includes an opening 103a for track 101 to traverse.

As used here (claims, specification, and other definitions) the following terms have the following meaning:

Articles and phases such as, “the”, “a”, “an”, “at least one”, and “a first”, “comprising”, “having” and “including” here are not limited to mean only one, but rather are inclusive and open ended to also include, optionally, two or more of such elements and/or other elements. In terms of the meaning of words or terms or phrases herein, literal differences therein are not superfluous and have different meaning, and are not to be synonymous with words or terms or phrases in the same or other claims.

The term “and/or” is inclusive here, meaning “and” as well as “or”. For example, “P and/or Q” encompasses, P, Q, and P with Q; and, such “P and/or Q” may include other elements as well.

The term “abdominal area” as used herein has the meaning, the anatomical region above the abdomen and/or stomach.

The term “around” as used herein has the meaning, surrounding a body part.

The term “backside” as used herein has the meaning, the posterior side of a body part such as along a person's back.

The term “closure” as used herein has the meaning, a device, parts or elements that can be opened and closed, and when closed have holding power to remain closed.

The term “fabric” as used herein has the meaning sheet material made from woven fibers. As but one example of fabric the may be used, including fabric forming the inside of the support, such as a vest, is Ingeo™ fabric and/or fibers, by NatureWorks LLC, 15305 Minnetonka Boulevard, Minnetonka, Minn. 55345-1512, USA and Cargill. Such fabric and/or fiber are plant based (made from polylactic acid, PLA), and advantageously are hypoallergenic, and do not support bacterial growth. It is also machine washable and retains strength (and some testing indicates it actually has increase bursting strength) after machine washing and/or dry cleaning. These fabrics and fibers are believed to include and/or be based on that which is the subject(s) of one or more of U.S. Pat. Nos. U.S. Pat. No. 8,268,954 B2, U.S. Pat. No. 8,377,353 B2, U.S. Pat. No. 8,182,725 B2, 7,232,664; 7,141,410; and 7,015,302 and U.S. published patent application numbers 2007/0187876; 2007/0148748; and 2007/0092956, and U.S. Provisional Patent Application No. 60/995,868, filed 28 Sep. 2007 which are each hereby incorporated fully by reference. DuPont's Sorona® fiber may be another example. Other fabrics and/or fibers and/or blends (plant based or renewable or not), such as cotton, silk, more conventional polymers (e.g. nylon, rayon, polyester, etc.), and/or blends may be used as well.

The term “falling condition” as used herein has the meaning, a situation where a user stumbles and/or starts to fall. It typically is associated with a stumble or fall at the rate of acceleration of gravity or, when the fall is an angle or vector not perpendicular with a floor, then some fraction of gravity.

The term “feed out of said retractor slowly” as used herein has the meaning, line being pulled out of the retractor below a speed and/or acceleration that causes the retractor to grab the line.

The term “flexible material” as used herein has the meaning, rope, chord, chain wire (coated or not), webbing and/or a combination thereof that is sufficiently flexible that it cannot transmit substantial compressive force and yet is strong in tensile strength.

The term “flexible support line” as used herein has the meaning, line that is flexible material and is connected to, or adapted to be connected to a support.

The term “for being washed” as used herein has the meaning, made of a material that can be washed 20 times without significant reduction in strength.

The term “front side” as used herein has the meaning, the side generally opposite the backside.

The term “grabs” as used herein has the meaning, mechanically engaging and holding something else, such as a line, from further significant movement.

The term “hard lumps” as used herein has the meaning, rigid and/or stiff parts or segments that are readily palpable by a user along their torso's skin.

The term “hook and loop fabric interface” as used herein has the meaning, plastic and/or fabric connectors. One common brand thereof is Velco™.

The term “medical care rooms” as used herein has the meaning, a patient and/or treating room in a hospital, clinic, doctor's office and/or the like.

The term “movable” as used herein has the meaning, capable of being moved without undue effort.

The term “non-restraint” means here a system, device, material, method or equipment that is not a “restraint” within the definition by the U.S. federal Centers for Medicare & Medicaid Services, HHS (CMMS), 42 C.F.R. §482.13(e)(1)(i), “A restraint is—(A) Any manual method, physical or mechanical device, material, or equipment that immobilizes or reduces the ability of patient to move his or her arms, legs, body, or head freely . . . (C) A restraint does not include devices . . . or methods that involve the physical holding of a patient . . . to protect the patient from falling out of bed, or to permit the patient to participate in activities [e.g. walking] without the risk of physical harm . . . ”.

The term “overhead track” as used herein has the meaning, a track and/or track system and/or rail mounted higher than six feet, and typically mounted (directly or indirectly) to a structural ceiling. Regarding rail, as but one example, the Unilin® UniRail® Rigid Rail Horizontal Lifeline System (offered by Capital Safety Group (Northern Europe) Limited Private Limited Company United Kingdom 5 Merse Road, Moons Moat, North Industrial, Estate Redditch, Worcestershire United Kingdom B98 9HL) provides a good example rail and carriage movable along the rail. Other such products are suitable as well.

The term “openable” as used herein has the meaning, capable of and designed to be opened.

The term “one-handed operation” as used herein has the meaning, only requiring one hand to perform.

The term “outer free edge” as used herein has the meaning, an edge of something (straight, curved, both or otherwise) at the outer layer of a support or vest.

The term “over” as used herein has the meaning, lying on top of, with or without intermediate layers and/or structure.

The term “path” as used herein has the meaning, direction(s) where something can be moved that are pre-established by the structure of something (e.g. a rail). A path can be straight, curved, open, closed, loop, a combination thereof, and/or otherwise.

The term “radio notification signal” as used herein has the meaning, one or more receivable signals transmitted over radio wave frequenc(ies).

The term “ready removal” as used herein has the meaning, easily removable without undue strength and without separate tools.

The term “removably attachable connection” as used herein has the meaning, a connection that is or can be attached to something else and can be removed from it without damage. It may include one or more loops, clips, carabiners, hooks, snaps, hook and loop interface and/or otherwise.

The term “retractor” as used herein means a device for storing part or all of the line and that is sensitive to and grabs the line upon withdrawal. Preferable, the retractor grabs the line (webbing or otherwise) within 40, and preferably 20 and preferably 10 centimeters of rapid payout. Preferably, the retractor grabs the line and meeting the standards of Federal Motor Vehicle Standards (FMVS) 209 and/or 302. Preferably, the retractor “is sensitive to webbing withdrawal shall be subjected to an acceleration of 3 m/s² (0.3 g) within a period of 50 milliseconds (ms) while the webbing is at 75 percent extension, to determine compliance with 54.3(j)(1)(ii). The retractor shall be subjected to an acceleration of 7 m/s² (0.7 g) within a period of 50 ms, while the webbing is at 75 percent extension . . . ” and/or a “retractor that is sensitive to [line] withdrawal shall be subjected to an acceleration no greater than 0.3 g occurring within a period of the first 50 ms and sustaining an acceleration no greater than 0.3 g throughout the test, while the webbing is at 75 percent extension . . . ” 49 C.F.R. §571.209(j). As but one example, a suitable retractor includes a seat-belt retractor offered by Beam's Seatbelts (www.seatbelts.net) Model No. HL800. Other examples would work as well.

The term “user support” as used herein has the meaning, a vest, harness, straps, pants and/or a combination thereof around a user and strong enough to support the full weight of a 200 pound user.

The term “vest” as used herein has the meaning, a fabric garment-like device for wearing around the abdomen and/or torso and with two shoulder openings.

The term “vertically disposed strap-handle” as used herein has the meaning, a strap that may be user grabbed and is oriented generally parallel to a user's superior-inferior axis.

The term “webbing” as used herein has the meaning, generally flat, flexible line. It often is made from woven fibers.

The invention may include any one or more articles or devices made by any of the claimed methods and/or may by different methods but with a claimed composition.

The language used in the claims and the written description and in the above definitions is to only have its plain and ordinary meaning, except for terms explicitly defined above. Such plain and ordinary meaning is defined here as inclusive of all consistent dictionary definitions from the most recently published (on the filing date of this document) general purpose Webster's dictionaries and Random House dictionaries.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A safety support system for use in medical care rooms, comprising:
an overhead track providing a track path between a first location and at least one other location;
a retractor and a flexible support line fed into and out of said retractor;
wherein said retractor is movable along said track;
and wherein said retractor allows said line to feed out of said retractor slowly but grabs said line when there is a falling condition of a user;
a removably attachable connection between said line and a user support;
said user support around said user to support said user in the event of a fall, wherein said user support is a non-restraint support, said non-restraint support having a closure on the user's front side of said support, said closure being openable by a one-handed operation of said user within less than three seconds to facilitate ready removal of said non-restraint support.

2. The system of claim 1 wherein said non-restraint support comprises a vest.

3. The system of claim 2 wherein said removably attachable connection comprises a hook and loop fabric interface located over an abdominal area of said user support.

4. The system of claim 3 and further comprises a vertically disposed strap-handle positioned, at least in part, within two inches an outer free edge of said vest and positioned generally over said hook and loop fabric interface when on a user.

5. The system of claim 4 wherein said non-restraint support is made of flexible material and lacks any substantial hard lumps on its backside to facilitate user sleeping on their back while wearing the non-restraint support.

6. The system of claim 5 wherein said non-restraint support lacks any metal components.

7. The system of claim 6 wherein said non-restraint support is adapted for being washed in an automatic clothes washing machine.

8. The system of claim 7 wherein the non-restraint support comprises fabric which is anti-bacterial and is hypoallergenic.

9. The system of claim 8 wherein the track path runs between the user's bed and a bathroom.

10. The system of claim 9 wherein said retractor is lightweight and is non-motorized and is pulled along said track by user tension on said support line.

11. The system of claim 10 wherein said support line includes flexible webbing.

12. The system of claim 11 wherein upon a user fall, said retractor grabs said line such that line pulled out from said retractor is less than about 10 centimeters in a falling condition.

13. The system of claim 12 and further comprising a radio notification signal sent to a nurse's station upon one or both of: (a) a falling event; and, (b) removal or attachment of said line to said support.

14. The system of claim 1 wherein said removably attachable connection comprises a hook and loop fabric interface located over an abdominal area of said user support.

15. The system of claim 2 and further comprises a vertically disposed strap-handle positioned, at least in part, within two inches an outer free edge of said vest and positioned generally over said hook and loop fabric interface when on a user.

16. The system of claim 1 wherein said non-restraint support is made of flexible material and lacks any substantial hard lumps on its backside to facilitate user sleeping on their back while wearing the non-restraint support.

17. The system of claim 1 wherein said non-restraint support lacks any metal components.

18. The system of claim 1 wherein said non-restraint support is adapted for being washed in an automatic clothes washing machine.

19. The system of claim 1 wherein the non-restraint support comprises fabric which is anti-bacterial and is hypoallergenic.

20. The system of claim 1 wherein the track path runs between the user's bed and a bathroom.

21. The system of claim 1 wherein said retractor is lightweight and is non-motorized and is pulled along said track by user tension on said support line.

22. The system of claim 1 wherein said support line includes flexible webbing.

23. The system of claim 1 wherein upon a user fall, said retractor grabs said line such that line pulled out from said retractor is less than about 10 centimeters in a falling condition.

24. The system of claim 1 and further comprising a radio notification signal sent to a nurse's station upon one or both of: (a) a falling event; and, (b) removal or attachment of said line to said support.

25. A safety support system for use in medical care rooms, comprising:
an overhead track providing a track path between a first location and at least one other location;
a retractor and a flexible support line fed into and out of said retractor;
wherein said retractor is movable along said track;
and wherein said retractor allows said line to feed out of said retractor slowly but grabs said line when there is a falling condition of said user;
a removably attachable connection between said line and a user support;
said user support around said user to support said user in the event of a fall, wherein said user support is a non-restraint support;
wherein upon a user fall, said retractor grabs said line such that payout from said retractor of said line is less than about 5 inches.

26. The system of claim 25 wherein upon a user fall, said retractor grabs said line such that line pulled out from said retractor is less than about 10 centimeters in a falling condition.

27. For a safety support system for use in medical care rooms comprising an overhead track providing a track path between a first location and at least one other location; a retractor and a flexible support line fed into and out of said retractor; wherein said retractor is movable along said track; and, wherein said retractor allows said line to feed out of said retractor slowly but grabs said line when there is a falling condition of said user, a vest comprising;
an attachable connection to attach the vest to the line;
a vest body around said user to support said user in the event of a fall, wherein said user support is a non-restraint support, said non-restraint support having a closure on the user's front side of said support, said closure being openable by a one-handed operation of said user within less than three seconds to facilitate ready removal of said non-restraint support.

28. The vest of claim 27 wherein said removably attachable connection comprises a hook and loop fabric interface located over an abdominal area of said user support, and further comprises a vertically disposed strap-handle positioned, at least in part, within two inches an outer free edge of said support and positioned generally over said hook and loop fabric interface when on a user.

29. The vest of claim 28 wherein said non-restraint support is made of flexible material and lacks any substantial hard lumps on its backside to facilitate user sleeping on their back while wearing the non-restraint support, and is adapted for being washed in an automatic clothes washing machine, and comprises fabric which is anti-bacterial and is hypoallergenic.

30. The vest of claim 27 wherein said non-restraint support is made of flexible material and lacks any substantial hard lumps on its backside to facilitate user sleeping on their back while wearing the non-restraint support, and is adapted for being washed in an automatic clothes washing machine, and comprises fabric which is anti-bacterial and is hypoallergenic.
